(19) United States
(12) Patent Application Publication
(10) Pub. No.: US 2003/0097468 A1
(43) Pub. Date: May 22, 2003

(54) Configuration of computer networks

(76) Inventor: Youssef Hamadi, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/281,923

(22) Filed: Oct. 28, 2002

(30) Foreign Application Priority Data
Oct. 27, 2001 (GB) 0125895.3

(51) Int. Cl. G06F 15/173; G06F 15/16

(52) U.S. Cl. 709/238; 709/252

(57) ABSTRACT

Systems involving generations of a complex node respresentation of a PNNI peer group are provided. Use is made of a set of restrictive costs, such as a transition matrix, defining the restrictives costs of paths between pairs of border nodes of the peer group. The complex node representation generation method is based on the group evolution process of the logical group representation of a peer group, and use is also made of the spanning tree representation of a network. Complex node representations generated by the disclosed possible number of exception bypasses.

### FIELD OF THE INVENTION

The present invention relates to computers and particularly although not exclusively, to a computer entity, a method of establishing a spanning tree in a network of computers, a method of operating a computer within a network, a method of file querying within a network, and a method of establishing a spanning tree in a network of computer entities.

### BACKGROUND TO THE INVENTION

Historically, computer networks have been based upon two main architectures, being a client server architecture, in which plurality of client computers refer to a server computer entity for data storage, and data processing functions, and in more recent years peer to peer networks, in which each computer entity is capable of acting as both client and/or server for any other computer entity in the network.

Referring to FIG. 1 herein, there is illustrated schematically an example of a simple computer network organized on the known client-server architecture. A server computer entity 100 has relatively high data processing capacity and relatively high data storage capacity compared to each of a plurality of client computer entities 101-103. The server serves up processing and/or data storage functionality to each of the plurality of client computers. In general, data is stored in a file system or database at the server computer, and the client computer entities access the data over local area network (LAN) or wide area network (WAN) connections 104-106.

Referring to FIG. 2 herein, there is illustrated schematically a network of computer entities arranged on a peer to peer basis. Each of a plurality of computer entities 200-203 communicates with one or more of the other computer entities within the network, and can act either as a client to any other computer entity in the network, and/or as a server to another computer entity. Each computer entity therefore has two modes of operation, firstly acting as a client, where for example it may access data stored on another computer entity in a network, or secondly acting as a server, in which case another computer entity may access data stored from the computer entity itself. In a general case of a peer to peer environment of connected computer entities, each computer entity represents topologically a node in a network. Connections between nodes can be arbitrary in the general case.

A known protocol for establishing network connectivity between computer entities on a peer to peer basis is the Gnutella protocol. The Gnutella protocol has been available since early in the year 2000, and is a de facto standard as is known by those skilled in the art.

A problem with a known Gnutella protocol, is that file querying is inefficient. The Gnutella protocol deals with file querying by implementing a set of repeated broadcasts. Owing to the distributed nature of connections in a peer to peer network, the topology of the network is uncertain and may contain loops. If repeated broadcasts traverse network loops, then broadcast messages can be contained within loops. The broadcast features in the Gnutella network do not allow for efficient querying in a high complexity network.

Referring to FIG. 3 herein, there is illustrated schematically an example of file querying operation of a known Gnutella network. An example of FIG. 3 comprises a plurality of computer entities C1-C8, connected by a plurality of links L1-L15. If, for example computer C1 is looking for a file, computer C1 only has knowledge of the three computers to which it is directly connected, that is computers C2, C3 and C4. C1 issues a broadcast request for a file, for example a JPG file, file.JPG. The broadcast message propagates over links L1, L2 and L3 to computers C2, C3, and C4 respectively. Computer C1 does not have a map of the whole network, but does store the URL addresses, or other network addresses, of the computer entities to which it is adjacently connected. A computer receiving a file request message, relays the message to other computer entities to which it is connected. Therefore, for example computer entity C2 receiving the message will relay the message to connected computer C4, C5, computer C3 receiving the message will relay the file request message to computers C2, C4, C6, C8, and computer C4 receiving the message will relay the message to computers C2, C3, C5, C7.

As the message propagates the network, each peer computer may see the same file request message several times, which is inefficient and uses up network bit rate capacity and processing capacity at each computer node.

The known Gnutella protocol implements a solution to endless propagation of file request messages, by limiting the number of times a message can be relayed. Each message is assigned a “time to live” parameter, which defines the number of hops between nodes that the message can make before the message is deleted. In each message is added a counter a “time to live” counter, and the accepted highest number that the counter can be set within the protocol is 7. The counter is decremented every time the message is received by a computer. When the counter reaches zero, the computer does not propagate the message.

Referring to FIG. 4 herein, there is illustrated schematically propagation of a file request message having a time to live parameter of 7, propagating in the network of FIG. 3. The message passes from computer node C1 to C4 to C5 to C6 to C7 to C3, back to C1. Here the network is small enough to ensure that a time to live of 7 allows a complete traversal.

Referring to FIG. 5 herein, there is shown an example, of a network comprising a plurality of nodes shown as circles, connected by a plurality of links shown as lines, where each node comprises a computer, and each link comprises a network connection between two computers. Computers within 6 links of a source computer 500 originating a file request will receive a file request message, where the “time to live” lifetime counter of the file request message is 5. However, since the message does not propagate beyond 6 hops, only computers within a distance of 6 hops, within region 501, receive the message. More distant computers, which are separated from the source computer by more than 6 hops, in the region 502 never receive the file request message, since the message does not propagate enough hops to reach them.

Therefore, the known Gnutella solution to endless propagation of messages relies on terminating messages after a pre-determined number of re-send operations by computers, without knowledge of network topology. The range of the message is therefore limited, and the message may not reach distant nodes separated from an originating node by more than a pre-determined number of hops. Further, within a lifetime of a message, the message can still propagate redundantly around loops within the network.

The known time to live solution does not solve the problem of duplication of messages, it only limits its severity. Secondly, querying is incomplete. According to the Gnutella protocol, if a file is located more than a maximum of 8 hops away from a node requesting a file, the file request message will never reach the node which actually stores the requested file.

Modification of the Gnutella protocol to extend the range of a message by increasing the maximum number of hops, would simply tend towards the general case of endless propagation of messages. There would still be propagation of messages around loops, and there would still be a maximum range of message, determined by the time to live parameter.

within networks of computer entities connected on a peer to peer basis.

### SUMMARY OF THE INVENTION

According to one aspect of the present invention there is provided a method of establishing a spanning tree in a network of peer to peer connected computer entities, said method comprising:

sending a plurality of configuration messages each describing a network configuration amongst said plurality of computers; and

determining from said configuration messages, a spanning tree connectivity between said plurality of computers of said network.

Further aspects and features of the present invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a simple network of computer entities connected in a known hierarchical client-server architecture;

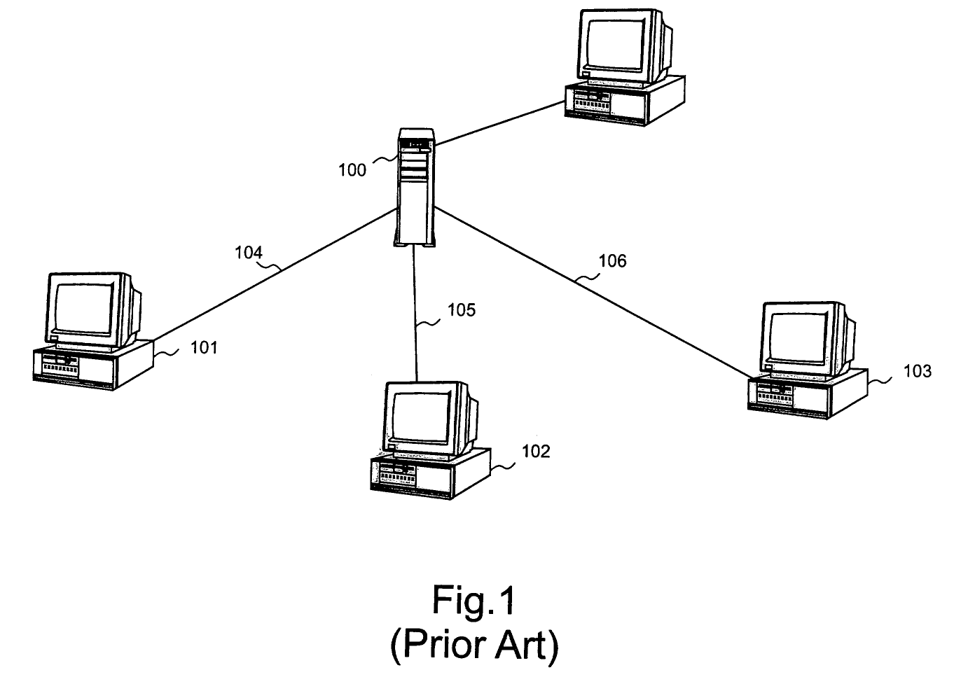

FIG. 2 illustrates schematically a network of computers connected according to a known peer to peer architecture;

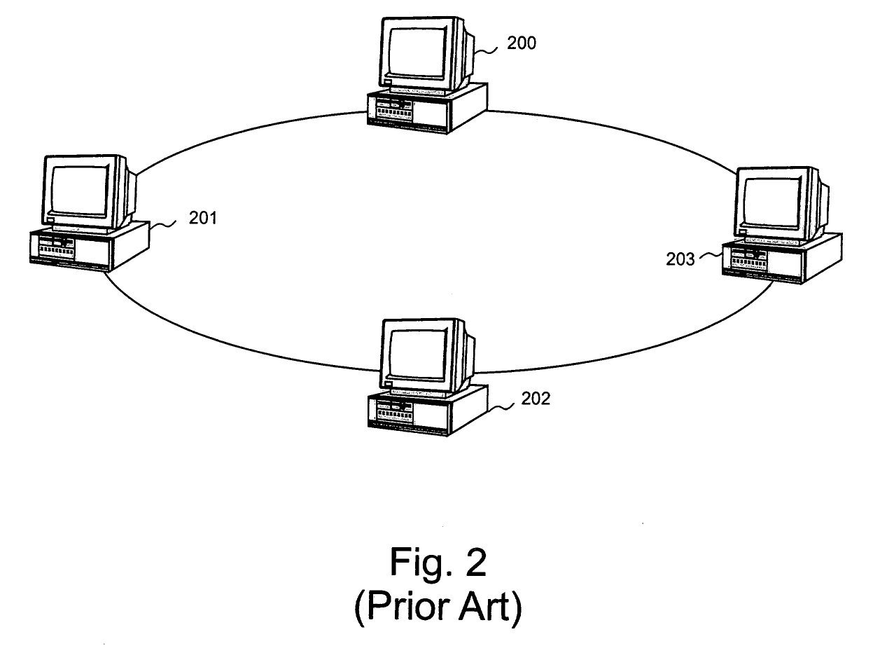

FIG. 3 illustrates schematically a computer network represented as a set of nodes and links, to illustrate file querying according to a known Gnutella protocol;

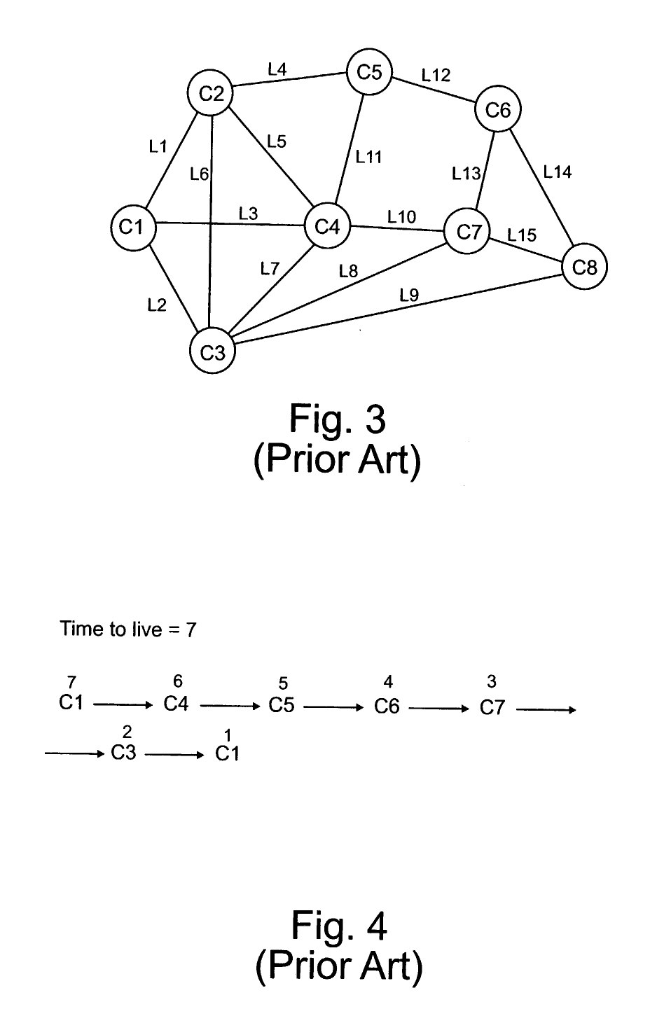

FIG. 4 illustrates schematically a time to live parameter of a message according to the known Gnutella protocol;

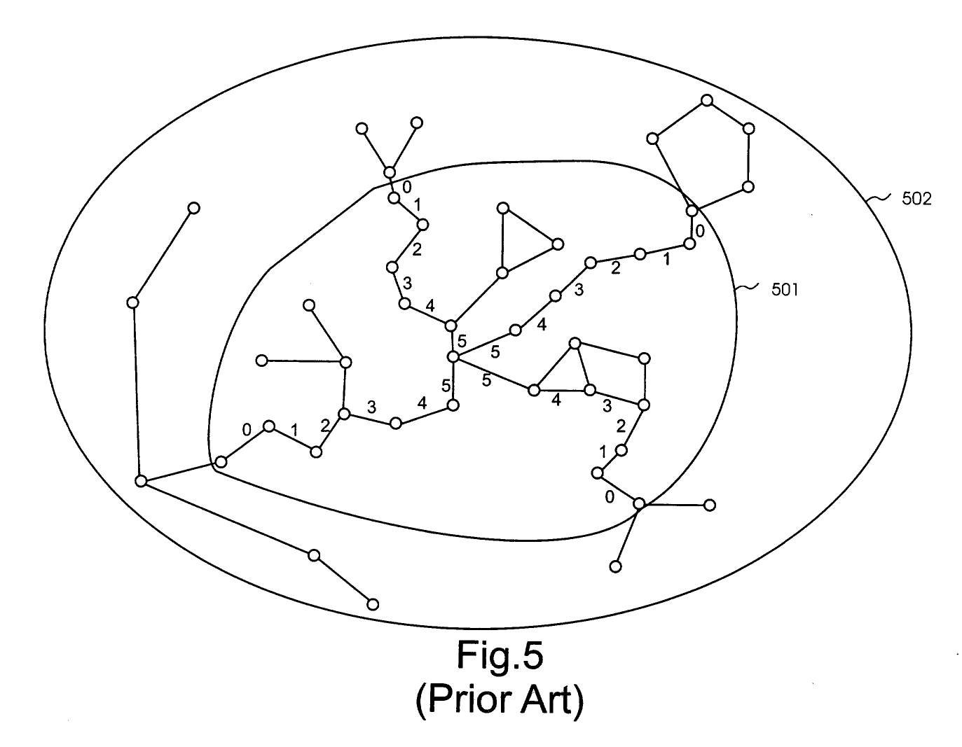

FIG. 5 illustrates schematically a known problem of message propagation in a Gnutella network of peer to peer connected computers;

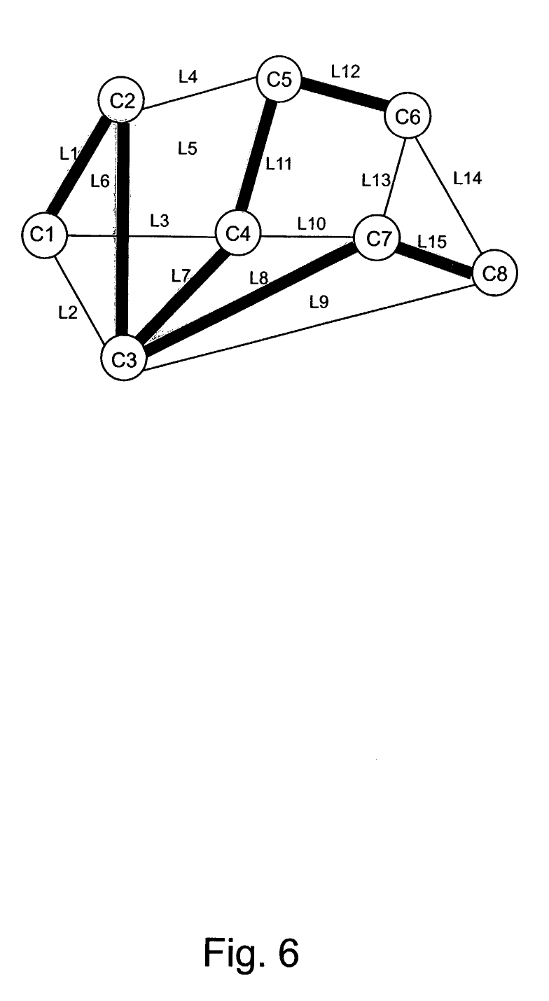

FIG. 6 illustrates schematically an example of a spanning tree in a simple network of nodes and links where nodes represent computers, and links represent possible binary connections between pairs of computers;

FIG. 7 illustrates schematically components of a computer according to a specific implementation of the present invention;

FIG. 8 illustrates schematically logical components of the computer of FIG. 7;

FIG. 9 illustrates schematically a method of operation of a network comprising a plurality of computers connected together on a peer to peer basis, according to a specific implementation of the present invention;

FIG. 10 illustrates schematically process steps carried out by spanning tree algorithm at a local computer, for taking account of tree configuration data received from acquaintance computers within the network;

FIG. 11 illustrates schematically a broadcast procedure implemented by a spanning tree algorithm of a computer, for broadcasting a spanning tree configuration to a plurality of acquaintance computers;

FIGS. 12 to 19 illustrate schematically a sequence of connections from the view point of a single host computer operating a specific method according to the present invention;

FIG. 20 illustrates schematically a file query message broadcast operation from a local computer in the network, along links specified by an established spanning tree; and

FIG. 21 illustrates schematically operation of a local computer, upon receipt of a file request query message from an acquaintance computer.

### DETAILED DESCRIPTION OF A SPECIFIC MODE FOR CARRYING OUT THE INVENTION

There will now be described by way of example a specific mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

A specific mode method for file querying in a network of peer to peer connected computers comprises election of a root host computer which forms the root of a spanning tree in the network. This is achieved by a global identification of the root computer. In the case of identifying computers by Ethernet number, the root computer is the one with the smallest Ethernet number. Since the identification of the root is exchanged throughout the network, it is non optimal to use IP numbers of the computers, as this could give rise to situations where host computers directly address the root computer, to increase speed of connection. This situation is to be avoided. The Ethernet number or use of the Ethernet number to identify computers is a good solution since each number is unique and does not allow direct connections.

Each host computer considers its local configuration, that is, the local connections of the computer to other peer computers. The local configuration which represents the identification of the root and the distance to this root defined by a number of hops. Initially, each host computer determines that it is the root. Therefore, each computer entity determines that a distance to the root is zero. This information is addressed to connected host computer entities. By considering the incoming information about local configurations, of other connected computers, each computer is able to find a best neighbor (except for the root) representing its father in a spanning tree. The computation of the spanning tree is reflexive. This means that each host is able to find which acquaintances are its “children” in the spanning tree.

Configurations of each computer connected locally to a host computer are compared using the distance to root and the Ethernet ID. This automatically connects a host computer to a shortest path to the root of a spanning tree. The father and the children of the host computer are set to be active.

A Gnutella servant sends search queries to active neighbors. As a result of computations at each computer, host computers are connected in a spanning tree, which means that a unique path between any pair of computers is established. Queries are made below and above each node in a network. When a node receives a query from its father in the tree, it forwards the query to its children in the tree. When a host receives a query from a child, it forwards it to other children and also to its father. In this way, each host computer receives a query once. With a plurality n of interconnected host computers, a query is globally processed by the use of n−1 messages.

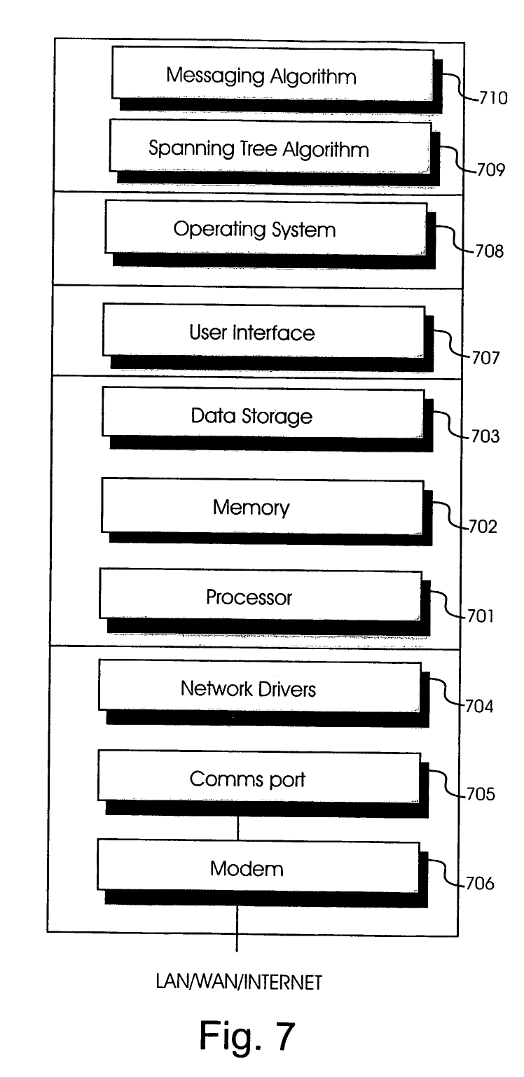

Referring to FIG. 6 herein, there is illustrated schematically a representation of a network of computer entities, communicating on a peer to peer basis, implementing a query messaging method according to a specific implementation of the present invention. A network of 8 peer to peer connected computer entities C1-C8 are represented logically, together with their interconnections, as nodes and links, wherein each computer entity is represented by a node, and a possible computer to computer connection between adjacent computer entities is represented as a link, there being a plurality of links L1-L15 representing the complete connectivity of the computers.

Each computer is provided with a spanning tree algorithm, enabling each computer to send query messages to other computers across the network in an efficient manner, without messages circulating within loops of the network. Computers on the network are connected according to the known Gnutella protocol, in which computers connect on a peer to peer basis. Each computer entity stores a list of other computers in the network, (herein referred to as acquaintances) with which the computer “knows”, that is, has a connection to.

Each computer operates its own query algorithm to determine the topology of a spanning tree, connecting the computer entity to other computers within the network.

A spanning tree is a path between nodes on the network, where two peers are connected by only one route. Spanning trees are well known in the field of telecommunications networks. In the network of FIG. 6, whichever two nodes Ci, Cj are connected there is only one path between those nodes Ci and Cj respectively. For example, to connect computers C1 and C8, the following path is possible C1-C2-C3-C7-C8.

In the resulting spanning tree, there is no duplication of routes, between any two computers, and any query messages sent across the spanning tree will reach their destination host computer in the absence of any time to live parameter. The spanning tree therefore allows the property of complete querying. Further, querying is optimal and N hosts can be reached by propagation of n−1 messages.

Once a spanning tree is established in a network, computers can communicate with each other by sending file query messages, where the file query messages are routed from parent to child, and from child to parent along the spanning tree.

Further, the messaging method has scaleability and does not break down as the size of network increases. Additionally, using a spanning tree allows the prophecy of accountability of searching. That is, when a query message is sent over a spanning tree, it is known to reach its destination host computer. Therefore a definite positive or negative confirmation of whether that host computer contains a specified file can be obtained.

In the network of FIG. 6, the spanning tree is shown as a set of links in bold. Links which are shown by lighter lines are set to be inactive. Links which are shown in bold are set to be active and connect binary pairs of computers. The spanning tree has a root node C1, and a plurality of leaf nodes C6, C8. Between the root node and leaf nodes are a plurality of intermediate nodes C2-C5, C7. Each node computer has an associated cost parameter myCost which comprises a value equal to the number of hops along the spanning tree from that computer to the root computer. A hop is defined as an active link in the spanning tree. The cost parameter is the minimum number of active links which a message must traverse from the computer to the root computer. In the example of FIG. 6, the cost of computer C4 is three, because a message has to traverse three links L7, L6, L1 to reach the computer C1.

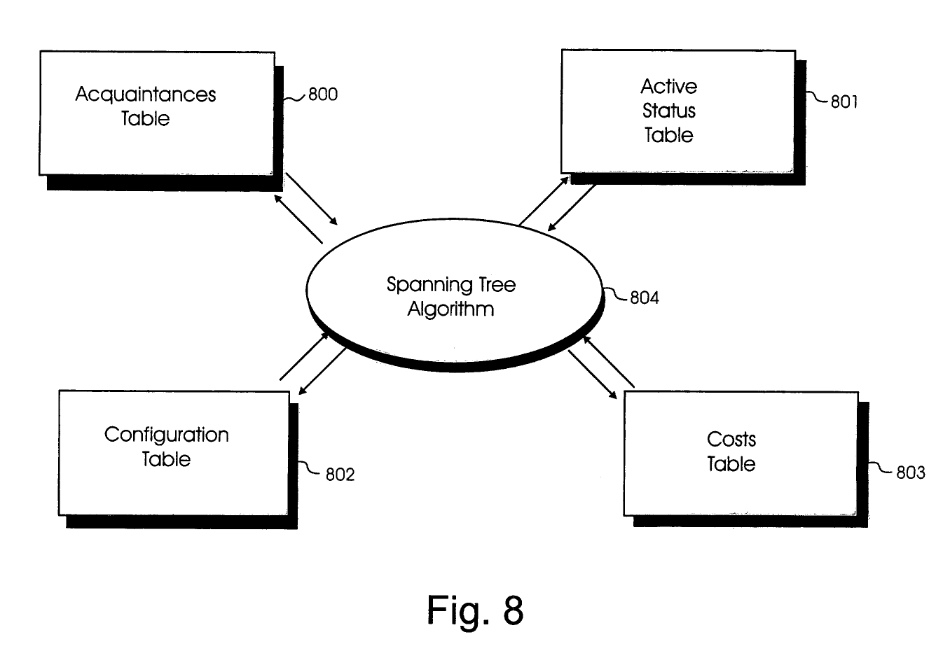

Referring to FIG. 7 herein, there is illustrated schematically components of a computer within the peer to peer network shown schematically in FIG. 6. Each computer entity 700 comprises: a processor 701; associated volatile memory 702; a data storage device 703, for example a hard disk drive or the like; one or more network drivers 704 for communicating with other computers on a network; one or more communications ports 705, connecting to a local area network, wide area network, or the like, for communicating with other computer entities, optionally one or more modems for communicating with other computers; a user interface 707, for example the known Windows 2000, Windows NT, Linux, or Unix, operating systems; a spanning tree algorithm 709 for establishing spanning tree connections; and a messaging application 710 containing a querying algorithm or sending, receiving and processing of query messages.

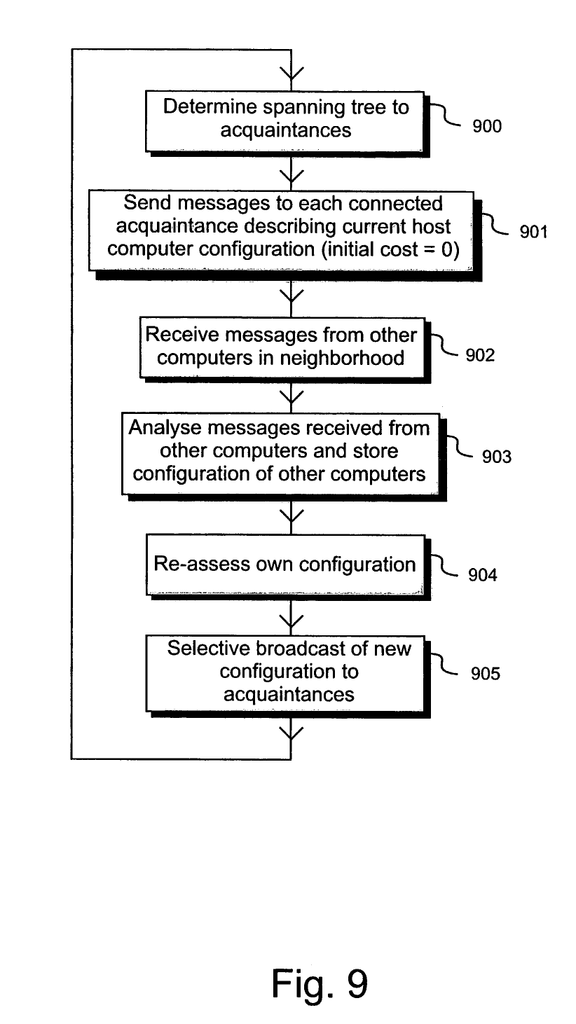

Referring to FIG. 8 herein, there is illustrated schematically logical interaction between query algorithms, and a set of data tables stored in data storage device 703. Each host computer entity stores an acquaintances table 800 comprising a list of other computers to which the computer is connected; an active status table 801 listing a status for each of the acquaintance computers compared with the host computer; a configuration table 802 stores local configuration data describing a configuration of each acquaintance computer relative to the host computer; and a cost table 803 storing data describing a cost assigned to each acquaintance computer.

A status of “true” is applied to an acquaintance computer if that acquaintance is used for transmission.

Each computer operates a spanning tree algorithm 804. Once a spanning tree is established in the network, then messages are sent by the messaging algorithm 710 over the network to acquaintance computers, along the established spanning tree network.

Each Gnutella code uses the following data parameters:

acquaintances: a set of connected host computers;

father: the direct father of the local process in the tree (father ε acquaintances);

myCost: local cost of the root, i.e. length of the shortest path to the root;

myld: local identification of the process, for example Ethernet number;

config: this table gives the local configuration of each acquaintance;

trHost: this data describes the host which gave the local configuration, i.e. the transmitting host;

cost: this parameter gives the cost of each acquaintance;

Active: this parameter gives the status for each acquaintance and is set to true if the host is used for transmission.

The following algorithm is executed in each Gnutella host. The execution is fully asynchronous.

father: = myId
myConfig: = myId
myCost: = 0
trHost: = myId
For each h in acquaintances
SendMsgTo:h (myConfig,myCost, father)

Config(h): = myId
Host(h): = myCost
Active(h): = true

//Gnutella event loop
While (true)

ReceiveMsgFrom:id (hConfig,hCost, hFather)
// reported config for id is better than the stored one
If hConfig < config(id) | (hConfig = config(id) & hCost <cost(id))

config(id): = hConfig
cost(id): = hCost
// reported config is the best in the neighbourhood
If forall h ε e acquaintances − {id}, such that hConfig <
config(id) (hConfig = config(id) & hCost < cost(id))
father:=id
active(id): = true
// reported config is better than local one
If cost+1 <myCost | (cost+1 = myCost & hconfig < |
myConfig) (cost+1 = myCost & hconfig = my Config & id <
trHost)

myConfig: = hConfig
myCost: = cost+1
trHost: − id
// selective broadcast its new config
For each h in acquaintances

If myConfig < config(h) | (myConfig = config(h)
& myCost < cost(h))
SendMsgTo:h (myConfig, myCost, father)
active(h) :=true

else active(h) :=false

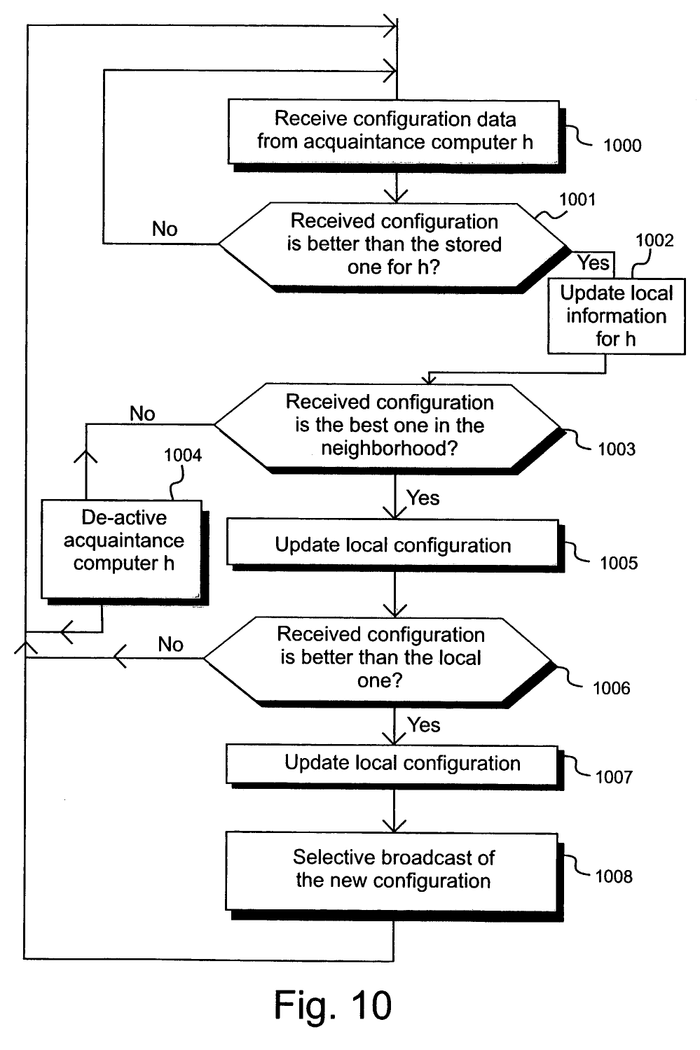

Referring to FIG. 9 herein, there is illustrated schematically overall process steps operated by messaging algorithm 710. In process 900, a spanning tree is calculated, to determine a set of routes to a plurality of acquaintance computers, which are listed in the acquaintance table 800. A known spanning tree algorithm may be used, for example a spanning tree algorithm as disclosed in IEEE 802.1, as is known by those skilled in the art. In process 901 for each acquaintance computer, a message is sent by the host computer describing the current configuration of the host computer.

The configuration data sent to each acquaintance comprises data describing the host computer and comprises:

myCost data describing a local cost parameter to a root of the spanning tree. The cost is calculated as the length of the shortest path to the root. Initially, this is set to zero, since each computer considers itself to be to the root of a spanning tree.

father data. Initially each computer considers itself to be the father, and sends its own unique identification data, for example Ethernet address, to its acquaintances.

myconfig data, being a data identifying the host computer. This is unique identifier data, for example the Ethernet number of the host computer.

In process 902, the host computer receives messages from other computers in the neighborhood. The messages are analyzed in process 903 and configurations of other computers are stored.

In process 904, the host computer reassess its own configuration, taking into account the configuration data of other acquaintance computers received from those acquaintances. In process 905, the host computer selectively broadcasts its revised configuration data to acquaintances listed in the acquaintances table 800.

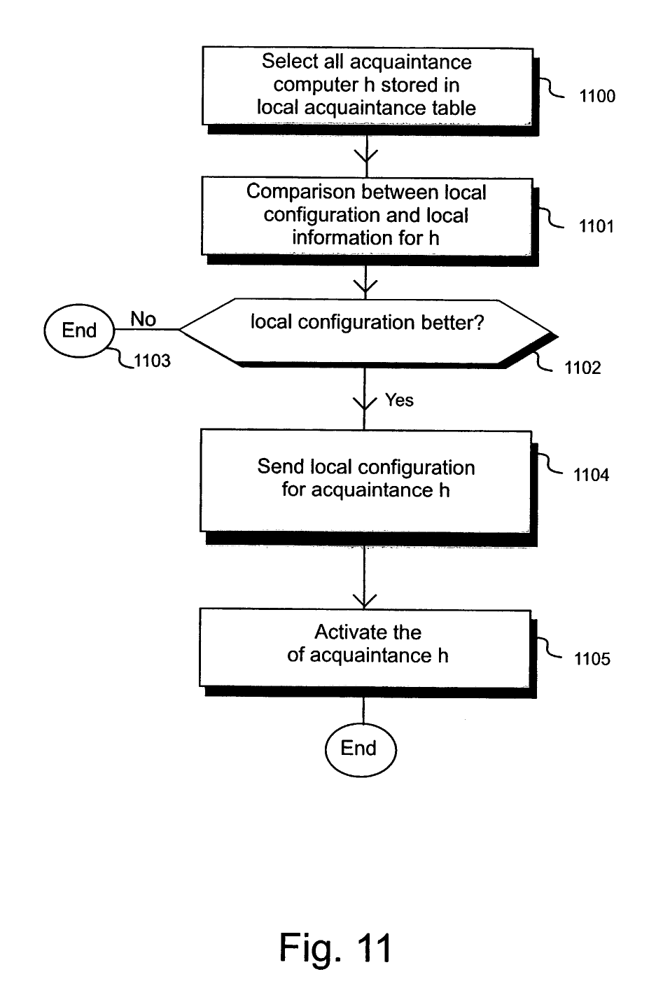

Referring to FIG. 10 herein, there is illustrated schematically processes carried out by a local computer in the network when it receives configuration data from another host computer in the network to which the local computer is connected. In process 1000 the local computer receives configuration data from the acquaintance computer h over a network link. In process 1001, the computer reads the configuration data, and determines whether the received configuration data from acquaintance computer h is better than the configuration data already stored for the acquaintance computer h. If the received configuration data is not more optimum than that stored locally on a computer entity for the acquaintance computer h, then the computer takes no further action and cycles back to process 1000 waiting for further configuration data from the acquaintance computer h. However, if in step 1001 the configuration data stored on the computer entity is better than that stored for the acquaintance computer h, then in process 1002 the computer updates the locally stored configuration data for the acquaintance computer h with that recently received. In step 1003, the computer entity checks whether the received configuration data is the best one in the neighborhood, by checking the received configuration data for the acquaintance computer h with other stored configuration data for other acquaintance computers, stored locally on the local computer's data storage device. If the received configuration data recently received from acquaintance computer h is not as optimal as other configuration data stored in the immediate neighborhood of the computer entity, then in step 1004 acquaintance computer h is set to be inactive on the stored database of the local computer. If in step 1003 the received configuration data from the acquaintance computer h is found to be the best one in the neighborhood, then in step 1005 the local configuration data for the local computer is updated to be that supplied by the acquaintance computer h. In step 1006, it is determined whether the received configuration is better than the locally stored configuration. If not, then the computer returns to process 1000, awaiting further configuration data from acquaintance computer h. If, in step 1005 the received configuration data is better than the local configuration data, then in step 1007 the local configuration data is replaced with the received configuration data from acquaintance computer h, and in step 1008, the computer selectively broadcasts the newly adopted configuration data, being that received from acquaintance computer h, to other acquaintance computers of which the local computer stores address data.

Consequently, on receiving a new configuration data from an acquaintance computer h, a local computer compares it with configuration data stored for other acquaintance computers, and its own local configuration data. In order for the local computer to adopt the received configuration data as its own local configuration data, then the local computer must have determined that the received configuration data is the best available within the neighborhood of acquaintance computers, of which the local computer is aware, and is also better than the local computer's own currently stored configuration data. If these conditions are satisfied then the local computer adopts the received configuration data from the acquaintance computer as its own configuration data, and then broadcasts that configuration data to all other acquaintance computers for which it stores address data.

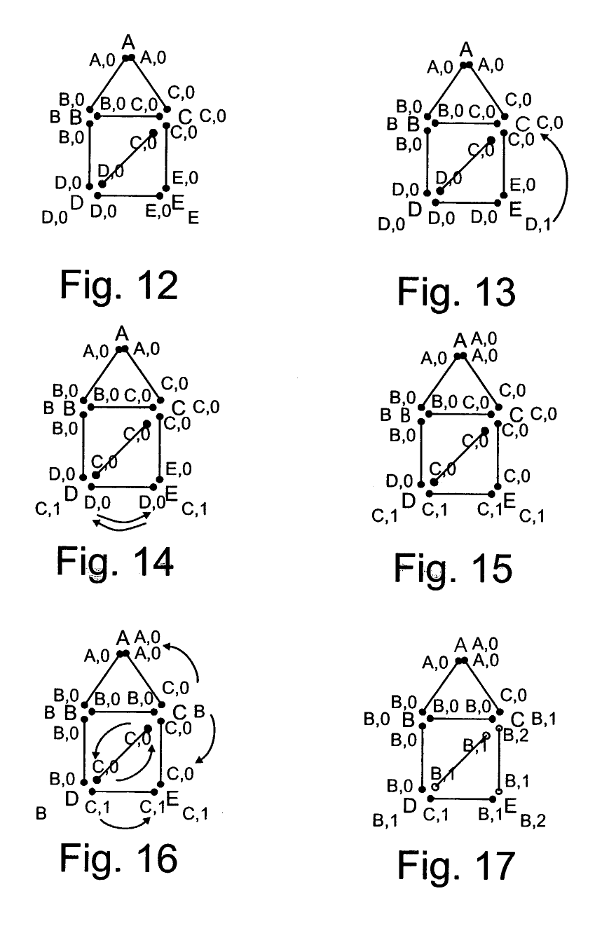

Referring to FIG. 11 herein, there are illustrated schematically processes carried out at a local computer, to selectively broadcast the configuration data stored at that local computer to one or a plurality of acquaintance computers of that local computer. In process 1100 all acquaintance computers for which address data is stored in an acquaintance table of the local computer are selected. In step 1101, a comparison is made the local configuration of the local computer entity and a local configuration which is stored for each acquaintance computer h. In step 1102, if the local configuration data stored at the local computer is not better than that for a particular acquaintance computer, then no further action is taken at step 1103. However, if the configuration data stored by the local computer entity is better than the configuration data stored by an acquaintance computer entity, then in step 1104, the configuration data of the local computer entity is sent to the acquaintance computer h. In step 1105, the status of the acquaintance computer h is set to active within the database of the local computer.

Therefore, computers finding that they themselves have a lower cost than an acquaintance computer propagate their own tree configuration data to those higher cost acquaintance computers.

The cumulative effect is that higher cost links between computers become deactivated, resulting, over time with the emergence of an efficient spanning tree.

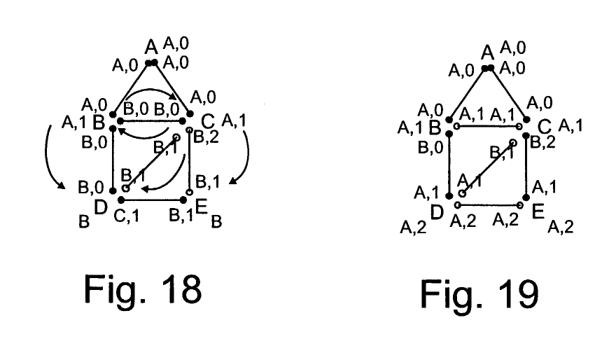

Referring to FIGS. 12 to 19 herein, there is illustrated schematically operation of the algorithm in a small network comprising five computers. The computation assumes an interleaving of messages in the network. For each host computer, a value of its local configuration is given by the data pair (myConfig, myCost) on each link, is denoted a local configuration of the related acquaintance and the status of the acquaintance (i.e. whether active or not). The highlighted host is the one sending configuration messages.

Initially, each local computer a, b, c, d, e considers itself to be the father of any spanning tree in the network, and to have a lowest cost i.e. zero of any computer in the network, and to be active. Each local computer operates a spanning tree algorithm, in order to establish a spanning tree in the network. All local computers operate their own spanning tree algorithms asynchronously, sending and receiving messages to other acquaintance computers within the network asynchronously. Each computer stores its own cost data mycost data describing acquaintance computers, that is computers to which the computer has information on the address, data describing whether each acquaintance computer is active or inactive, and configuration data. The configuration data describes the configuration of a spanning tree within which the computer is resident, and is the computer's own version of a spanning tree connecting the network.

Initially, each computer considers itself to be the root of a spanning tree, and sends messages out to other computers. However, as information between acquaintance computers is swapped, each computer modifies its own configuration data, either adopting the configuration data of an acquaintance computer, where that acquaintance computer has a lower cost parameter, and thereby adopting that acquaintance computer's version of the spanning tree, or where the computer determines it has a lower cost than an acquaintance computer, sending the computer's own configuration data, representing the computer's own version of the spanning tree to that acquaintance computer, with a cost data of the computer, enabling the acquaintance computer to compare the cost data of the computer with the acquaintance computer cost data and so that the acquaintance computer can determine whether or not to adopt the configuration data supplied by the computer.

Since each computer applies this process asynchronously of the other computers, over time, a dominant spanning tree configuration evolves, and becomes adopted by all computers in the network. The configuration data of each computer may not necessarily describe the whole of the spanning tree, but rather only the portion of the spanning tree as it applies to any acquaintance computers known to each computer. Therefore, the finally adopted configuration data stored by any computer describes a cost parameter of that computer, and additionally cost parameters of acquaintance computers known to the computer. Acquaintance computers having a lower cost parameter are regarded as “parents” of a computer, that is, nearer to a root node than the computer whereas acquaintance computers having higher cost parameters are regarded as “children” of a computer, that is nearer to leaf nodes than the computer. Therefore, each computer in the network attempts to establish a spanning tree, taking into account configuration messages received from other computers in the network and comparing those configurations with its own tree configuration which it stores locally in its local configuration table.

The algorithm disclosed herein, operates fully asynchronously. Regardless of interleaving of messages, in the final state, the network of computers is stabilized, and has a well balanced spanning tree. Balancing of the network is not inherent in the algorithm, but rather is encouraged by the algorithm when the initial network is strongly connected.

After operation of the algorithm, any file request within a number n of computer entities is globally processed with exactly n−1 messages. Moreover, there is no requirement for a time to live parameter in the messages. Messages automatically disappear when they reach their leaf nodes.

The above system may reduce message passing for querying, and ensure global querying and suppress the “time to live” information in messages. All of these features are suitable to Gnutella networks, and give scalability in a Gnutella network.

Whilst in the specific mode above, a time to live parameter is not applied to messages, the above system does not preclude or exclude the usage of a time to live parameter. In a second implementation, query messages sent over a spanning tree may be modified by addition of a time to live parameter, which restricts the number of hops between computers, which the message can carry out before being terminated. The known Gnutella time to live parameter may be used, or the time to live parameter may be specified to have a larger number than 7. In this way, the extent of exploration of a network by any host computer can be restricted, whilst maintaining the property of non duplication of query messages in exploring the network by any host computer.

Application of a time to live parameter to query messages sent over a peer to peer computer network, along a spanning tree may allow faster querying, but with a trade off that querying is now incomplete. The completeness of querying may be traded off against an improvement in querying speed, by selecting the lifetime of a time to live parameter applied to messages.

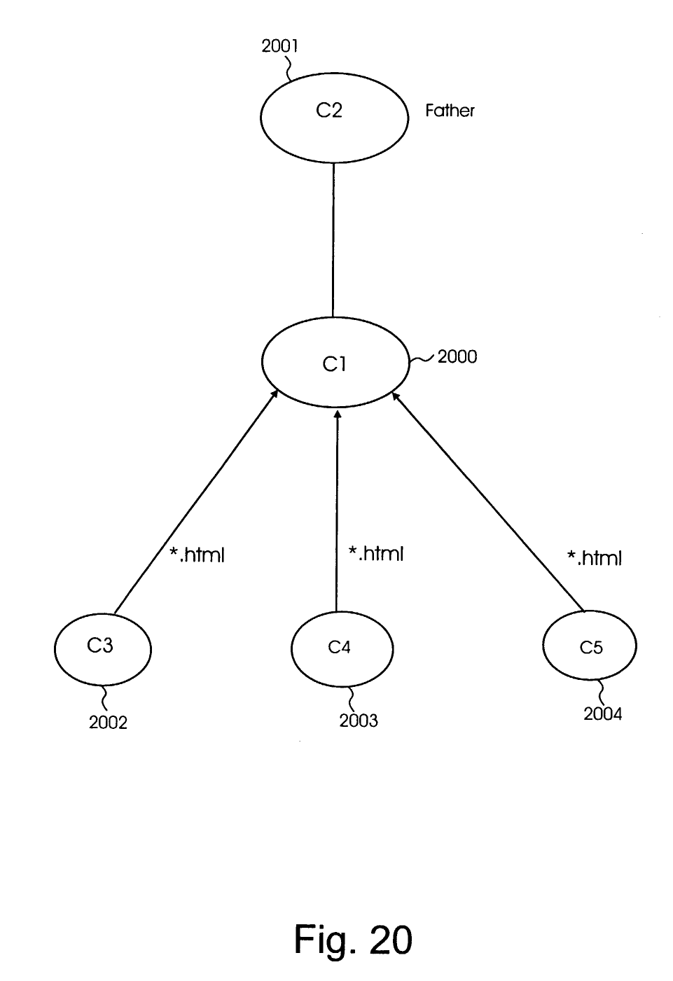

Referring to FIG. 20 herein, once the spanning tree has been established within a network, any computer can use the spanning tree to send a file query message to other computers within the network. In the example of FIG. 20, a local computer 2000 stores configuration data, specifying which computers within the network are “children” of that computer, and which computer in the network is the “father” of the local computer. On originating a file query message, the file query message is sent to the father computer, and each child computer specified in the configuration table. The links between the local computer and father computer, and between the local computer and each child computer, have already been established by the spanning tree algorithm.

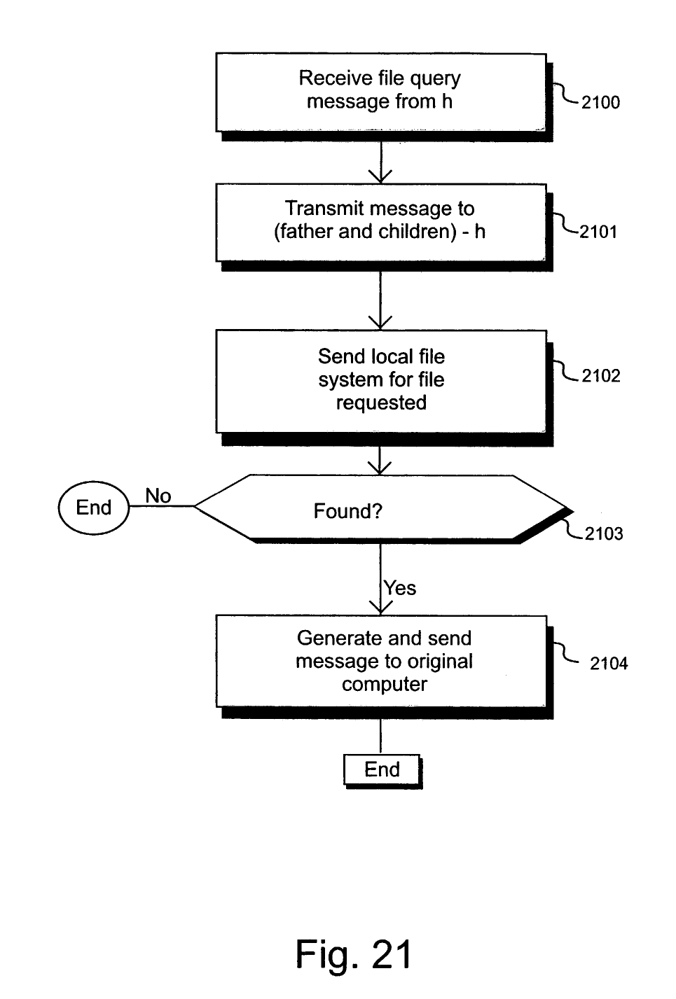

Referring to FIG. 21 herein, there is illustrated schematically processes carried out by messaging algorithm 709 at a local computer on receipt of a file query message from an acquaintance computer h. In process 2100, the computer receives a file query message from an acquaintance computer h. In process 2102, the computer transmits the message to the father and children acquaintance computers of the local computer, except for the acquaintance computer h from which the message derived. In process 2102, the local computer searches its local file system for a requested file as specified in the received message, and if the file is not found in step 2103, the computer takes no further action. However, if the file is found in step 2103, then in step 2104, the local computer generates and sends a message to the computer originating the message, indicating that the local computer stores the specified file in its own file system.

Whilst the specific mode described herein discloses a spanning tree evolved for an algorithm based upon IEEE 802.1, the skilled reader will appreciate that a variety of algorithms are known in the art which can give rise to distributed tree networks, and that other implementations using other tree generation algorithm types are possible.

Specific implementations according to the present invention may solve the problem of inefficient message propagation in networks of computer entities connected on a peer to peer basis.

Specific implementations of the present invention may to provide an efficient messaging.

In specific implementations disclosed herein, there is computed a distributed spanning tree, in a peer to peer environment.

Specific implementations disclosed herein may enable a peer to peer protocol, for example, a Gnutella protocol to be scaled up to very large peer to peer networks, by provision of a distributed spanning tree algorithm to an application level. Each search is propagated to the whole network, and each query is received once by a Gnutella servant computer. In a network of n hosts, exhaustive querying is done with n−1 point to point messages allied to a possible balancing of local operations.

1. A computer entity comprising:
at least one processor;
at least one data storage device;
an operating system;
a configuration table, said configuration table storing data describing a configuration of a spanning tree; and
a messaging component for sending and receiving of messages over a network, wherein said messaging component operates to send and receive said messages over a set of routes, according to said spanning tree, to a plurality of peer to peer connected computer entities.

2. The computer as claimed in claim 1, comprising:
an acquaintance table, said acquaintance table storing data describing a relationship between a plurality of other computers connected to said computer entity, wherein said relationship is specified as a father relationship or a child relationship for each said specified connected computer.

3. A method of establishing a spanning tree in a network of a plurality of peer to peer connected computer entities, said method comprising:
sending a plurality of configuration messages, each describing a network configuration, amongst said plurality of computers;
sending a plurality of status messages amongst said plurality of computers, each said status message describing a status of at least one of said plurality of computers;
sending a plurality of cost messages amongst said plurality of computers, each said cost message specifying a cost of an individual link between an individual pair of said computers; and
determining from said configuration messages, status messages and cost messages, a spanning tree connectivity between said plurality of computers.

4. The method of claim 3, wherein said process of determining comprises a plurality of determination processes each carried out locally at a said computer entity of said network.

5. The method of claim 3, comprising:
electing a said computer entity as a root node of said spanning tree.

6. A method of operating a local computer entity within a peer to peer network comprising a plurality of networked computers, for establishing a spanning tree within said network, said method comprising:
receiving configuration data from a plurality of other computer entities in said network;
for each said configuration data received from a said other said computer entity;
determining whether said other computer entity is active or not;
if said other computer entity is active, comparing said received configuration data with a locally stored configuration data stored at said local computer entity; and
if said received configuration data is more optimal than said locally stored configuration data, then adopting said received configuration data by replacing said locally stored configuration data with said received configuration data.

7. The method as claimed in claim 6, wherein said configuration data comprises:
for each said other computer;
data uniquely identifying a root computer entity which said other computer entity regards as being the root of a spanning tree;
establishing a cost data of said other computer entity to said root computer entity, said cost data comprising a number of hops as a shortest route between said root computer entity and said other computer entity.

8. The method as claimed in claim 6, further comprising:
transmitting said stored configuration data, and a local cost data of said local computer entity to a plurality of other computer entities in said network.

9. A method of operating a computer entity to establish a spanning tree within a network, said method comprising:
receiving a plurality of configuration messages from a plurality of other computer entities within said network;
analyzing said plurality of configuration messages received from said plurality of other computers within said network, to determine whether said configurations applied by any said other computer entity is more optional than a local network configuration stored at said computer entity;
if a said received configuration data of a said other computer entity in said network is more optimal than said local network configuration, then adopting said more optimal received configuration data at said computer entity; and
sending a configuration message describing a network configuration stored by said computer to each of a plurality of acquaintance computers connected to said computer entity in said network.

10. The method of claim 9, comprising:
for each said acquaintance computer:
storing data describing said acquaintance computer:
storing a cost parameter data describing a position of said acquaintance computer within a spanning tree.

11. The method of claim 9, comprising:
determining whether a said received configuration message from a said other computer entity describes said other computer entity as being active.

12. The method of claim 9, comprising:
storing a list of active said acquaintance computers at said computer entity; and
for each said active acquaintance computer, comparing a local cost value of said computer entity with a cost value of said acquaintance computer.

13. The method of claim 9, comprising:
storing a list of active said acquaintance computers at said computer entity;
for each said active acquaintance computer, comparing a local cost value of said computer entity with a cost value of said acquaintance computer;
if said local cost value is higher than said acquaintance cost value, then sending said local cost value to said acquaintance computer

14. A computer entity comprising:
at least one data processor;
at least one data storage device;
at least one database, said database comprising an acquaintance data table, storing data describing at least one connected acquaintance computer;
at least one messaging component;
an active status table, comprising data describing a transmission status of each said acquaintance computer;
a cost table, said cost table storing a cost data for each said acquaintance computer; and
a configuration table, storing data describing a local configuration of each said acquaintance computer.

15. A method of file querying in a network comprising a plurality of peer to peer connected computer entities capable of communicating with each other, said method comprising:
configuring a set of connections between said plurality of computers in a spanning tree arrangement, in which a said computer is designated as a root node of said tree, and at least one said computer is designated as a leaf node of said tree; and
propagating a plurality of file query messages amongst said plurality of computers, wherein said file query messages propagate along links of said spanning tree.

16. The method as claimed in claim 15, wherein a said computer receiving a said file query message operates to transmit said file query message to a parent computer of said receiving computer, and at least one child computer of said receiving computer.

17. The method as claimed in claim 16, wherein:
a said node computer receiving a said query message operates to:
read an address field of said message;
determine whether said address field addresses said computer or not;
if said address field addresses said computer, then reading a file address containing said query message;
check an internal file system of said node computer to determine whether said file exists on said computer; and
generate a response message containing a result message specifying whether said file exists at said node computer or not.

18. A method of establishing a spanning tree in a network of plurality of peer to peer connected computer entities, said method comprising;
sending a plurality of configuration messages, each describing a network configuration, amongst said plurality of computers; and
determining from said configuration messages, a spanning tree connectivity between said plurality of computers of said network.

19. Program data comprising instructions for operating a computer entity for carrying out the processes of:
communicating a plurality of messages over a set of routes according to a spanning tree;
storing data describing a relationship between a plurality of computer entities connected in a network, wherein said relationship is specified as a relationship selected from the set of a father relationship and a child relationship, for each of said plurality of computer entities.

20. A computer entity storing program data comprising instructions for operating a computer entity for carrying out the processes of:
communicating a plurality of messages over a set of routes according to a spanning tree;
storing data describing a relationship between a plurality of computer entities connected in a network, wherein said relationship is specified as a relationship selected from the set of a father relationship and a child relationship, for each of said plurality of computer entities

21. A data storage medium storing program data comprising instructions for operating a computer entity for carrying out the processes of:
communicating a plurality of messages over a set of routes according to a spanning tree;
storing data describing a relationship between a plurality of computer entities connected in a network, wherein said relationship is specified as a relationship selected from the set of a father relationship and a child relationship, for each of said plurality of computer entities.

22. Program data carrying instructions for operating a computer entity to perform the processes of:
sending amongst a plurality of computers a plurality of configuration messages, each describing a network configuration;
sending a plurality of status messages amongst said plurality of computers, each said message describing a status of at least one of said plurality of computers;
sending a plurality of cost messages amongst said plurality of computers, specifying a cost of an individual link between an individual pair of said computers; and
determining from said configuration messages, status messages and cost messages, a spanning tree connectivity between said plurality of computers.

23. A computer entity carrying program data carrying instructions for operating a computer entity to perform the processes of:
sending amongst a plurality of computers a plurality of configuration messages, each describing a network configuration;
sending a plurality of status messages amongst said plurality of computers, each said message describing a status of at least one of said plurality of computers;
sending a plurality of cost messages amongst said plurality of computers, specifying a cost of an individual link between an individual pair of said computers; and
determining from said configuration messages, status messages and cost messages, a spanning tree connectivity between said plurality of computers.

24. A data storage medium carrying program data carrying instructions for operating a computer entity to perform the processes of:
sending amongst a plurality of computers a plurality of configuration messages, each describing a network configuration;
sending a plurality of status messages amongst said plurality of computers, each said message describing a status of at least one of said plurality of computers;
sending a plurality of cost messages amongst said plurality of computers, specifying a cost of an individual link between an individual pair of said computers; and
determining from said configuration messages, status messages and cost messages, a spanning tree connectivity between said plurality of computers.

25. Program data comprising instructions for causing a local computer entity to perform a method of:
receiving configuration data from a plurality of other computer entities in a network;
for each said configuration data received from another computer entity;
determining whether said computer entity is active or not;
if said computer entity is active, comparing said received configuration data with a locally stored configuration data stored at said local computer entity; and
if said received configuration data is more optimal than said locally stored configuration data, then adopting said received configuration data by replacing said locally stored configuration data with said received configuration data.

26. A computer entity comprising a data storage medium carrying program data carrying instructions for operating a computer entity to perform the processes of:
sending amongst said plurality of computers a plurality of configuration messages, each describing a network configuration;
sending a plurality of status messages amongst said plurality of computers, each said message describing a status of at least one of said plurality of computers;
sending a plurality of cost messages amongst said plurality of computers, specifying a cost of an individual link between an individual pair of said computers; and
determining from said configuration messages, status messages and cost messages, a spanning tree connectivity between said plurality of computers.

27. A data storage medium storing program data carrying instructions for operating a computer entity to perform the processes of:
sending amongst a plurality of computers a plurality of configuration messages, each describing a network configuration;
sending a plurality of status messages amongst said plurality of computers, each said status message describing a status of at least one of said plurality of computers;
sending a plurality of cost messages amongst said plurality of computers, specifying a cost of an individual link between an individual pair of said computers; and
determining from said configuration messages, status messages and cost messages, a spanning tree connectivity between said plurality of computers.

28. Program data comprising instructions for controlling a computer entity to perform the processes of:
receiving a plurality of configuration messages from a plurality of other computer entities within a network comprising said computer and a plurality of computer entities;
analyzing said plurality of configuration messages received from said plurality of other computer entities within said network, to determine whether said configurations applied by any one or more of said other computer entities is more optimal than a local network configuration stored at said computer entity;
if a said received configuration data of a said other computer entity in said network is more optimal than said local network configuration, then adopting said more optimal received configuration data at said computer entity; and
sending a configuration message describing a network configuration stored by said computer entity to each of a plurality of acquaintance computers connected to said computer entity in said network.

29. Program data for comprising instructions for causing a computer to perform the method of:
configuring a set of connections between a plurality of computers in a spanning tree arrangement, in which a said computer is designated as a root node of said tree, and at least one said computer is designated as a leaf node of said tree; and
propagating a plurality of file query messages amongst said plurality of computers, wherein said messages propagate along links of said spanning tree.

30. Program data comprising instructions for operating a computer entity to perform a method of establishing a spanning tree in a network of a plurality of peer to peer connected computers entities, said method comprising;
sending a plurality of configuration messages, each describing a network configuration, amongst said plurality of computers;
determining from said configuration messages, a spanning tree connectivity between said plurality of computers.
